(19) United States
(12) Patent Application Publication
(10) Pub. No.: US 2023/0377202 A1
(43) Pub. Date: Nov. 23, 2023

(54) IMAGE COMPRESSION APPARATUS, IMAGE COMPRESSION METHOD, COMPUTER PROGRAM, IMAGE COMPRESSION SYSTEM, AND IMAGE PROCESSING SYSTEM

(71) Applicant: Sumitomo Electric Industries, Ltd., Osaka-shi, Osaka (JP)

(72) Inventor: Li YUE, Osaka-shi, Osaka (JP)

(73) Assignee: Sumitomo Electric Industries, Ltd., Osaka-shi, Osaka (JP)

(21) Appl. No.: 18/027,660

(22) PCT Filed: Jul. 26, 2021
(86) PCT No.: PCT/JP2021/027502

§ 371 Date: Mar. 22, 2023

(30) Foreign Application Priority Data
Oct. 2, 2020 (JP) 2020-167734

(51) Int. Cl. G06T 9/00; G06T 7/11; G06T 7/20; G06V 10/25

(52) U.S. Cl. CPC G06T 9/00; G06T 7/11; G06T 7/20; G06V 10/25; G06V 2201/07

(57) ABSTRACT

An image processing apparatus includes a target region extraction unit configured to extract from an image, a target region that is a region including an object having a predetermined size, and an image compression unit configured to compress the image on the basis of a result of extraction of the target region.

### TECHNICAL FIELD

The present disclosure relates to an image compression apparatus, an image compression method, a computer program, an image compression system, and an image processing system.

This application claims priority based on Japanese Patent Application No. 2020-167734 filed on Oct. 2, 2020, and the entire contents of the Japanese patent application are incorporated herein by reference.

### BACKGROUND ART

With the progress of AI (artificial intelligence) techniques represented by deep learning in recent years, image compression techniques using AI have been studied (for example, see Non-PTL 1).

In the technique disclosed in Non-PTL 1, a saliency of each pixel in an image is calculated using a convolutional neural network (CNN) that is machine-learned using deep learning. Here, the saliency is a measure indicating how conspicuous a pixel is to a person's vision. Non-PTL 1 discloses a compression method in which the higher the saliency of a pixel is, the lower the compression ratio of the pixel is.

### PRIOR ART DOCUMENT

### Non Patent Literature

[Non-PTL 1] A. Prakash, N. Moran, S. Garber, A. Dilillo and J. Storer, ‘Semantic Perceptual Image Compression Using Deep Convolution Networks,’ 2017 Data Compression Conference (DCC), Snowbird, U T, 2017, pp. 250 to 259, doi: 10.1109/DCC. 2017.56.

### SUMMARY OF INVENTION

According to an aspect of the present disclosure, there is provided an image compression apparatus. The image compression apparatus includes a target region extraction unit configured to extract from an image, a target region that is a region including an object having a predetermined size; and an image compression unit configured to compress the image on the basis of a result of extraction of the target region.

According to another embodiment of the present disclosure, there is provided an image compression method. The image compression method includes extracting from an image, a target region that is a region including an object having a predetermined size, and compressing the image on the basis of a result of extraction of the target region.

A computer program according to another aspect of the present disclosure causes a computer to function as, a target region extraction unit configured to extract from an image, a target region that is a region including an object having a predetermined size; and an image compression unit configured to compress the image on the basis of a result of extraction of the target region.

An image compression system according to another aspect of the present disclosure includes a camera mounted in a moving body; and the image compression apparatus described above, the image compression apparatus being configured to compress an image captured by the camera.

An image processing system according to another aspect of the present disclosure includes the image compression apparatus described above; and an image decompression apparatus configured to acquire from the image compression apparatus, an image that has been compressed and decompress the acquired image that has been compressed.

It goes without saying that the computer program can be distributed via a computer-readable non-transitory recording medium such as a compact disc-read only memory (CD-ROM) or a communication network such as the Internet. The present disclosure can also be implemented as a semiconductor integrated circuit that implements part or all of an image compression apparatus.

### BRIEF DESCRIPTION OF DRAWINGS

FIG. 1 is a diagram illustrating an overall configuration of a driving assistance system according to a first embodiment of the present disclosure.

FIG. 2 is a block diagram illustrating an example of a configuration of a vehicle-mounted system according to the first embodiment of the present disclosure.

FIG. 3 is a block diagram illustrating a functional configuration of a processor according to the first embodiment of the present disclosure.

FIG. 4 is a diagram illustrating an example of an image acquired by an image acquisition unit from a camera.

FIG. 5 is a diagram for explaining a method of extracting a target region by a target region extraction unit.

FIG. 6 is a diagram for explaining a method of extracting a target region by a target region extraction unit.

FIG. 7 is a flowchart illustrating a processing procedure of a vehicle-mounted system according to the first embodiment of the present disclosure.

FIG. 8 is a flowchart illustrating the details of the image compression processing (step S3 in FIG. 7).

FIG. 9A is a diagram illustrating an example of a matrix of DCT (Discrete Cosine Transform) coefficients as a result of discrete cosine transform.

FIG. 9B is a diagram illustrating an example of DCT coefficients after the DCT coefficients shown in FIG. 9A are quantized using a first quantization table.

FIG. 9C is a diagram illustrating an example of DCT coefficients after the DCT coefficients shown in FIG. 9A are quantized using a second quantization table.

FIG. 10 is a block diagram illustrating an example of a configuration of a server according to the first embodiment of the present disclosure.

FIG. 11 is a flowchart illustrating a processing procedure of the server according to the first embodiment of the present disclosure.

FIG. 12 is a flowchart illustrating the details of the image expansion processing (step S23 in FIG. 11).

FIG. 13 is a diagram for explaining an object detection method according to the first embodiment.

FIG. 14 is a diagram for explaining an object detection method using a conventional technique.

FIG. 15 is a diagram illustrating experimental results of the object detection method according to the first embodiment and the object detection method using the conventional technique.

FIG. 16 is a block diagram illustrating a functional configuration of a processor included in a vehicle-mounted system according to a second embodiment of the present disclosure.

FIG. 17 is a diagram illustrating an example of a prediction target frame.

FIG. 18 is a flowchart illustrating a processing procedure of a vehicle-mounted system according to the second embodiment of the present disclosure.

FIG. 19 is a diagram illustrating an example of an object extracted from an input image.

### DESCRIPTION OF EMBODIMENTS

### Problems to be Solved by Present Disclosure

The conventional image compression method is a processing based on the assumption that a part conspicuous to the visual sense of a person is clearly seen when a compressed image is decompressed, and an object inconspicuous to the visual sense of a person is compressed at a high compression ratio.

For this reason, when the decompressed image is input to an object recognition apparatus for recognizing a predetermined object from an image, it is difficult to recognize an object that is inconspicuous to a person's vision. For example, in the case where a camera is mounted on a moving body such as a car, it is necessary to accurately recognize even a small car or the like that appears in a distant place. This is to perform driving assistance from an early point in time by recognizing a distant car.

The present disclosure has been made in view of such circumstances, and an object thereof is to provide an image compression apparatus, an image compression method, a computer program, an image compression system, and an image processing system that can realize image compression at a high compression ratio and accurate object recognition from an image after decompression.

### Advantageous Effects of Present Disclosure

According to the present disclosure, image compression at a high compression ratio and accurate object recognition from a decompressed image can be realized.

### Description of Embodiments of Present Disclosure

First, a summary of embodiments of the present disclosure is listed and described.

(1) An image compression apparatus according to disclosure, there is provided an image compression apparatus includes a target region extraction unit configured to extract from an image, a target region that is a region including an object having a predetermined size, and an image compression unit configured to compress the image on the basis of a result of extraction of the target region.

According to this configuration, image compression at a high compression ratio and accurate object recognition from the decompressed image can be realized by setting the compression ratio of the target region to such an extent that the object of the predetermined size included in the target region can be accurately recognized when the compressed image is decompressed and object recognition is performed.

(2) Preferably, the image compression unit may be configured to compress the image such that a compression ratio in the target region in the image is lower than a compression ratio in a region, in the image, other than the target region.

According to this configuration, the target region can be compressed at a lower compression ratio than the region other than the target region. For example, by setting the predetermined size to a size including a small object, image compression at a high compression ratio and accurate object recognition from an image after decompression can be realized.

(3) More preferably, the target region extraction unit may be configured to further extract a type of the object included in the target region, and the image compression unit may be configured to further add information about the type of the object to the image that has been compressed.

According to this configuration, when object recognition is performed by decompressing the compressed image, processing corresponding to the type of the object can be performed.

(4) In addition, the target region extraction unit may be configured to extract the target region that is a region including an object that has the predetermined size and that is of a type corresponding to a use of the image that has been compressed.

According to this configuration, the type of the object to be processed can be changed for each use of the compressed image. Thus, it is possible to realize object recognition according to use.

(5) In addition, the predetermined size may differ depending on a type of the object.

According to this configuration, it is possible to extract a target region having an appropriate size according to the type of the object. For example, by setting the predetermined size of a car to be larger than that of a person, it is possible to appropriately extract the target regions each including the car or the person.

(6) Further, the image compression unit may be configured to compress the image at a compression ratio corresponding to a type of the object included in the target region.

According to this configuration, the compression ratio can be changed for each type of object. As a result, for example, by compressing an object of a type in which recognition accuracy is more important at a lower compression ratio, it is possible to accurately recognize an object of an important type from the decompressed image.

(7) The image compression apparatus may further include a target region prediction unit configured to predict, on the basis of the target region extracted from a first image captured at a first time and on the basis of a second image captured at a second time different from the first time, the target region in the second image. The image compression unit may be configured to compress the second image on the basis of a result of prediction by the target region prediction unit.

According to this configuration, it is possible to omit the processing of extracting the target region from the second image. Thus, the image compression processing can be performed at high speed.

(8) Further, the target region prediction unit may be configured to predict a movement of the target region on the basis of the target region extracted from the first image and on the basis of the second image and predict the target region in the second image on the basis of the predicted movement and the target region extracted from the first image.

According to this configuration, the target region in the second image can be predicted from the movement of the target region. Thus, the target region in the second image can be accurately predicted.

(9) Further, the image may be captured by a camera mounted in a moving body.

According to this configuration, the compressed image can be utilized for safe driving assistance of the moving body.

(10) An image compression method according to another embodiment of the present disclosure includes extracting from an image, a target region that is a region including an object having a predetermined size, and compressing the image on the basis of a result of extraction of the target region.

This configuration includes, as the steps, characteristic processing in the image compression apparatus described above. Therefore, according to this configuration, it is possible to obtain the same operation and effect as the above-described image compression apparatus.

(11) A computer program according to another embodiment of the present disclosure causes a computer to function as a target region extraction unit configured to extract from an image, a target region that is a region including an object having a predetermined size, and an image compression unit configured to compress the image on the basis of a result of extraction of the target region.

According to this configuration, the computer can function as the above-described image compression apparatus. Therefore, the same operation and effect as those of the above-described image compression apparatus can be achieved.

(12) An image compression system according to another embodiment of the present disclosure includes a camera mounted in a moving body, and the image compression apparatus described above, the image compression apparatus being configured to compress an image captured by the camera.

According to this configuration, image compression at a high compression ratio and accurate object recognition from the decompressed image can be realized by setting the compression ratio of the target region to such an extent that the object of the predetermined size included in the target region can be accurately recognized when the compressed image is decompressed and object recognition is performed. Further, the compressed image can be utilized for safe driving assistance of a moving body.

(13) An image processing system according to another embodiment of the present disclosure includes the image compression apparatus described above, and an image decompression apparatus configured to acquire from the image compression apparatus, an image that has been compressed and decompress the acquired image that has been compressed.

According to this configuration, image compression at a high compression ratio and accurate object recognition from the decompressed image can be realized by setting the compression ratio of the target region to such an extent that the object of the predetermined size included in the target region can be accurately recognized when the compressed image is decompressed and object recognition is performed.

### Details of Embodiments of Present Disclosure

Embodiments of the present disclosure will now be described with reference to the drawings. It should be noted that each of the embodiments described below represents a specific example of the present disclosure. Numerical values, shapes, materials, constituent elements, arrangement positions and connection forms of constituent elements, steps, order of steps, and the like shown in the following embodiments are examples and do not limit the present disclosure. In addition, among the constituent elements in the following embodiments, constituent elements not recited in the independent claims are constituent elements that can be arbitrarily added. In addition, each drawing is a schematic diagram and is not necessarily strictly illustrated.

The same components are denoted by the same reference numerals. Since their functions and names are the same, their descriptions are omitted as appropriate.

### First Embodiment

[Overall Configuration of Driving Assistance System]

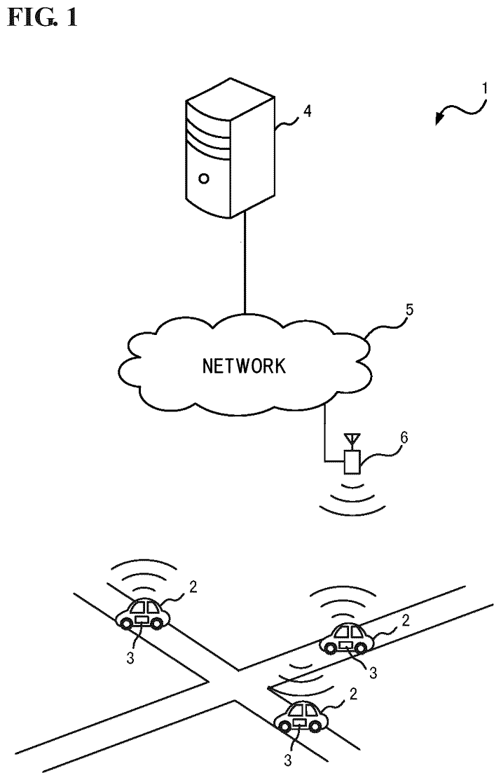

FIG. 1 is a diagram illustrating an overall configuration of a driving assistance system according to a first embodiment of the present disclosure.

Referring to FIG. 1, a driving assistance system 1 includes a plurality of vehicles 2 traveling on a road capable of wireless communication, one or a plurality of base stations 6 wirelessly communicating with vehicles 2, and a server 4 communicating with base stations 6 in a wired or wireless manner via a network 5 such as the Internet.

Base stations 6 include a macrocell base station, a microcell base station, a picocell base station, and the like.

Vehicles 2 include not only a normal passenger car (car) but also a public vehicle such as a route bus or an emergency vehicle. Vehicle 2 may be not only a four wheeled vehicle but also a two wheeled vehicle (motorcycle).

Each vehicle 2 includes a vehicle-mounted system 3 including a camera as described later, compresses image data (hereinafter, simply referred to as an “image”) obtained by photographing the surroundings of vehicle 2 with the camera, and transmits the compressed image to server 4 via network 5.

Server 4 receives the compressed image from each vehicle 2 via network 5 and decompresses the received compressed image. Server 4 performs predetermined image processing on the decompressed image. For example, server 4 executes recognition processing for recognizing vehicle 2, a person, a traffic light, and a road sign from the image, and creates a dynamic map in which the recognition result is reflected on the map data. Server 4 transmits the created dynamic map to each vehicle 2.

Each vehicle 2 receives the dynamic map from server 4 and performs a driving assistance processing or the like of vehicle 2 based on the received dynamic map.

[Configuration of Vehicle-Mounted System 3]

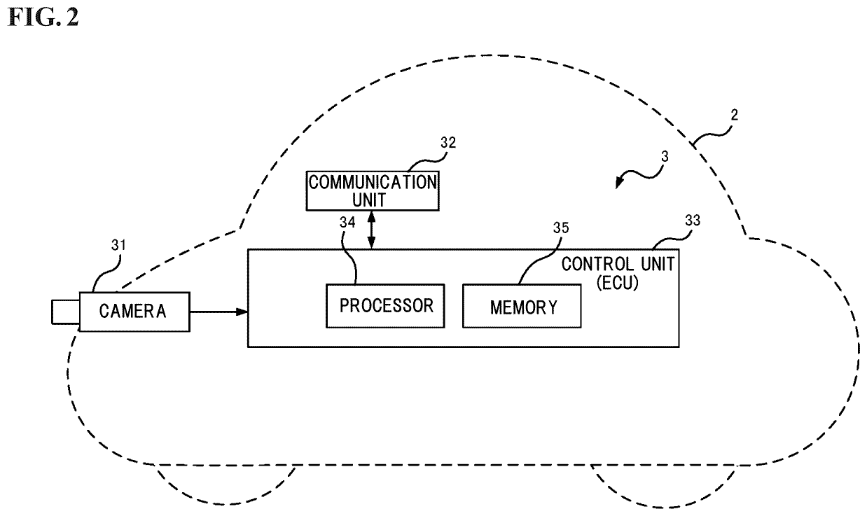

FIG. 2 is a block diagram illustrating an example of a configuration of vehicle-mounted system 3 according to the first embodiment of the present disclosure.

As shown in FIG. 2, vehicle-mounted system 3 of vehicle 2 includes a camera 31, a communication unit 32, and a control unit (ECU: Electronic Control Unit) 33.

Camera 31 is mounted on vehicle 2 and includes an image sensor that takes a video of the surroundings of vehicle 2 (particularly, the front of vehicle 2). Camera 31 is a monocular camera. However, camera 31 may be a compound eye camera. The video is composed of a plurality of time-series images.

Communication unit 32 is composed of, for example, a wireless communication device capable of performing communication processing corresponding to 5G (fifth generation mobile communication system). Communication unit 32 may be a wireless communication device already installed in vehicle 2, or may be a mobile terminal brought into vehicle 2 by a passenger.

The mobile terminal of the passenger is connected to an in-vehicle LAN (Local Area Network) of vehicle 2 to temporarily serve as an in-vehicle wireless communication device.

Control unit 33 is a computer device that controls the in-vehicle devices mounted on vehicle 2, including camera 31 and communication unit 32 of vehicle 2. The in-vehicle devices include, for example, a GPS receiver, a gyro sensor, and the like. Control unit 33 obtains the vehicle position of the own vehicle from the GPS signal received by the GPS receiver. Further, control unit 33 grasps the direction of vehicle 2 based on the detection result of the gyro sensor.

Control unit 33 includes a processor 34 and memory 35. Processor 34 is an arithmetic processing unit such as a microcomputer that executes a computer program stored in memory 35.

Memory 35 is configured by a volatile memory element such as a static RAM (SRAM) or a dynamic RAM (DRAM), a nonvolatile memory element such as a flash memory or an electrically erasable programmable read only memory (EEPROM), or a magnetic storage device such as a hard disk. Memory 35 stores a computer program executed by control unit 33, data generated when the computer program is executed by control unit 33, and the like.

[Functional Configuration of Processor 34]

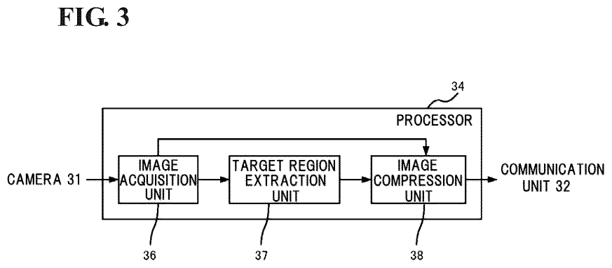

FIG. 3 is a block diagram illustrating a functional configuration of processor 34 according to the first embodiment of the present disclosure.

Referring to FIG. 3, processor 34 includes an image acquisition unit 36, a target region extraction unit 37, and an image compression unit 38 as functional processing units realized by executing a computer program stored in memory 35.

Image acquisition unit 36 sequentially acquires images in front of vehicle 2 captured by camera 31 in time series. Image acquisition unit 36 sequentially outputs the acquired images to target region extraction unit 37 and image compression unit 38.

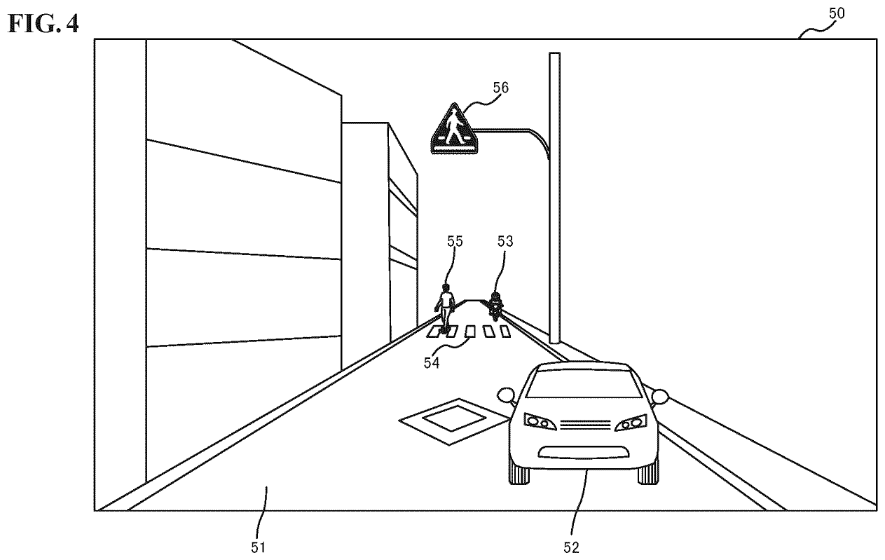

FIG. 4 is a diagram illustrating an example of an image (hereinafter referred to as “input image”) acquired from camera 31 by image acquisition unit 36.

For example, an input image 50 includes a car 52 and a motorcycle 53 running on a road 51, and a person 55 walking on a crosswalk 54 installed on road 51. Input image 50 includes a road sign 56.

Referring back to FIG. 3, target region extraction unit 37 acquires input image 50 from image acquisition unit 36 and extracts a target region, which is a region including an object having a predetermined size, from input image 50. Hereinafter, a method of extracting the target region will be specifically described.

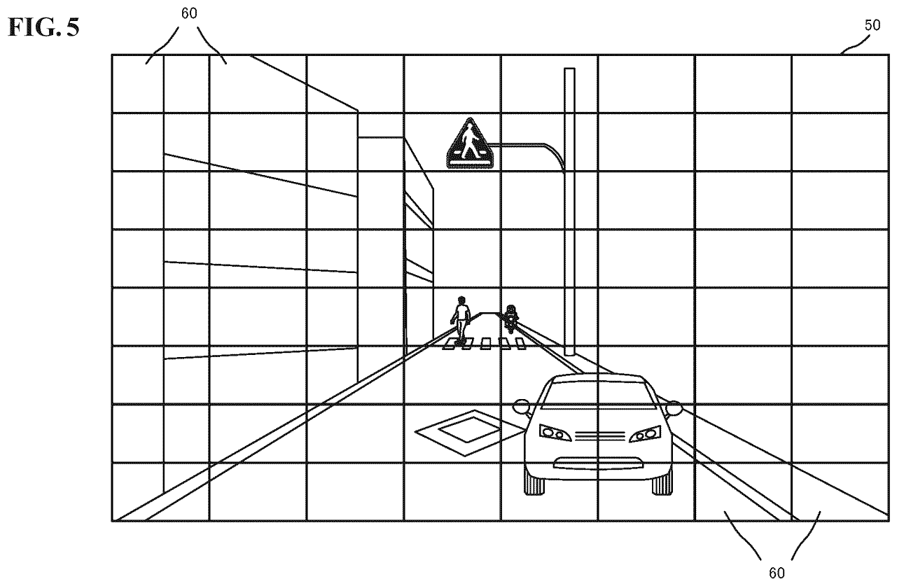

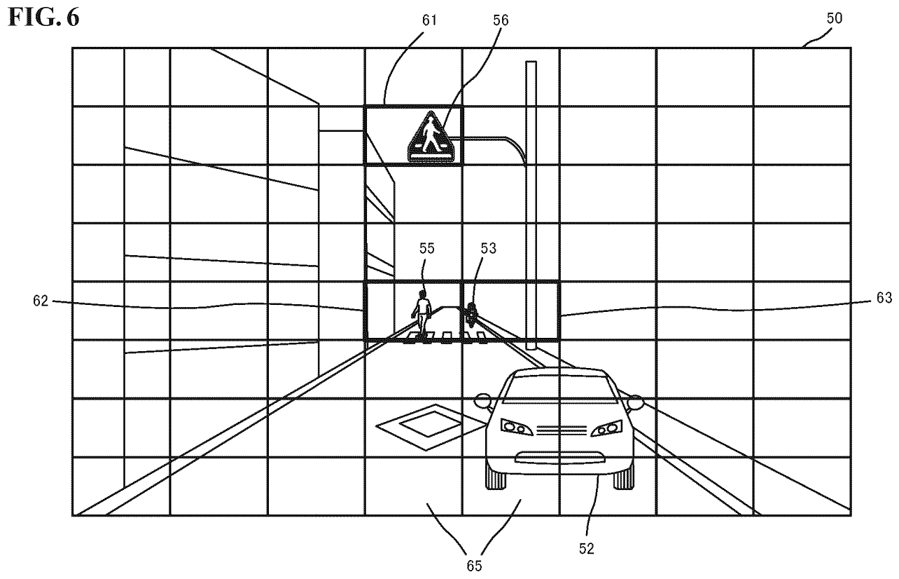

FIGS. 5 and 6 are diagrams for explaining a target region extraction method performed by target region extraction unit 37.

Referring to FIG. 5, target region extraction unit 37 divides input image 50 into a plurality of blocks 60. FIG. 5 shows an example in which input image 50 is divided into 64 (=8×8) blocks 60. The sizes of blocks 60 are determined in advance, and all of blocks 60 may have the same size, or some or all of blocks 60 may have different sizes.

Target region extraction unit 37 inputs an image of each block (hereinafter referred to as a “block image”) to a learning model to determine whether or not an object having a predetermined size is included in the block image. Here, the object having the predetermined size is, for example, an object satisfying the following Equation 1. Where sqrt (x) is the square root of x, and a and b are constants (where a<b).

a<sqrt(the number of pixels included in the circumscribed rectangle of the object)<b (Equation 1)

In the first embodiment, it is determined whether or not a small object is included in block 60 by setting a and b to small values.

The learning model is, for example, a convolution neural network (CNN), a recurrent neural network (RNN), an AutoEncoder, or the like. It is assumed that each parameter of the learning model is determined by a machine learning method such as deep learning using a block image including an object satisfying Equation 1 and a type of the object (hereinafter referred to as “object type”) as teacher data.

That is, target region extraction unit 37 inputs an unknown block image to the learning model, and thereby calculates, for each object type, a certainty factor indicating that an object satisfying Equation 1 is included in the block image. Target region extraction unit 37 extracts a block having the certainty factor equal to or greater than a predetermined threshold for each object type as a target region, and extracts the extracted object type as an object type of an object included in the target region. Target region extraction unit 37 outputs information of the extracted target region and object type to image compression unit 38. The target region information includes, for example, the upper left corner coordinates and the lower right corner coordinates of the target region. However, the expression method of the target region is not limited to this. For example, the target region information may include the upper left corner coordinates of the target region, and the number of pixels in the horizontal direction and the number of pixels in the vertical direction of the target region, or may include an identifier indicating the target region.

Here, the object type indicates the type of the object. In the first embodiment, the image is used for driving assistance of vehicle 2. Therefore, it is assumed that the object type includes a vehicle including a two wheeled vehicle or a four wheeled vehicle, a person, a road sign, and a traffic light. Note that the object type is not limited to this. For example, a bicycle may be included as a type different from the vehicle.

Further, the object type may be different for each use of the image. For example, when camera 31 is installed on a forklift traveling in a factory and the image is used for monitoring the inside of the factory, the object type may include a vehicle, a person, and a road sign, but may not include a traffic signal. This is because a traffic signal may not be installed in some factories.

In addition, when an image is used for package delivery, delivery support processing may be performed depending on an object serving as a mark. Therefore, for example, the object type may include a landmark such as a building or a signboard.

It is assumed that road sign 56, person 55, and motorcycle 53 satisfy Equation 1. Therefore, referring to FIG. 6, target region extraction unit 37 extracts a target region 61 and the road sign, a target region 62 and the person, and a target region 63 and the vehicle as pairs of target region and object type, respectively.

It is assumed that car 52 does not satisfy Equation 1. Therefore, target region extraction unit 37 does not extract car 52 as the target region. A block that is not extracted as the target region is referred to as a non-target region 65.

Referring back to FIG. 3, image compression unit 38 acquires input image 50 from image acquisition unit 36, and acquires the information of the target region and object type from target region extraction unit 37. Image compression unit 38 compresses input image 50 block by block. At this time, image compression unit 38 compresses the target region and the non-target region at different compression ratios. Specifically, image compression unit 38 compresses input image 50 so that the compression ratio in the target region is lower than the compression ratio in the non-target region. Here, the compression ratio is obtained by dividing the data amount of the block before compression by the data amount of the block after compression. Therefore, the amount of compressed data in the non-target region is smaller than the amount of compressed data in the target region. As a result, the image can be compressed at a high compression ratio as the entire image while maintaining the identity with input image 50 in the target region. Details of the compression processing by image compression unit 38 will be described later.

Image compression unit 38 adds information of the target region and the object type to compressed input image 50 and transmits the compressed input image 50 to server 4 via communication unit 32.

Note that processor 34 may receive a dynamic map from server 4 and perform a driving assistance processing or the like for vehicle 2 or the like based on the received dynamic map.

[Processing Flow of Vehicle-Mounted System 3]

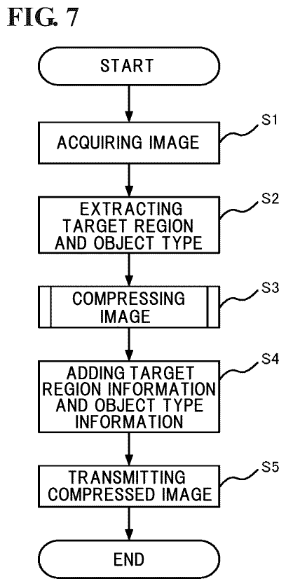

FIG. 7 is a flowchart illustrating a processing procedure of vehicle-mounted system 3 according to the first embodiment of the present disclosure.

Image acquisition unit 36 acquires an image from camera 31 (step S1). Target region extraction unit 37 extracts a target region and an object type from input image 50 (step S2).

Image compression unit 38 compresses input image 50 based on input image 50 and on the target region and the object type extracted by target region extraction unit 37 (step S3).

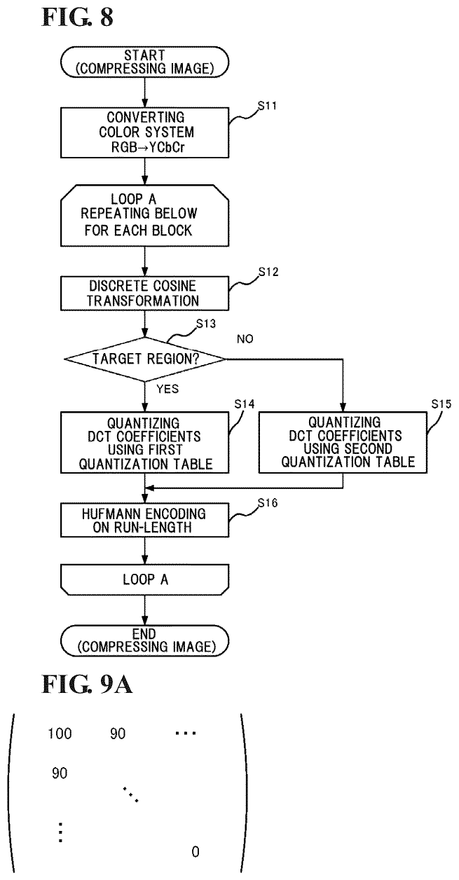

FIG. 8 is a flowchart illustrating the details of the image compression processing (step S3 in FIG. 7). The image compression processing shown in FIG. 8 is an application of JPEG (Joint Photographic Experts Group) compression.

Referring to FIG. 8, image compression unit 38 converts the color system of input image 50 (step S11). That is, each pixel of input image 50 includes an R signal, a G signal, and a B signal of the RGB color system. Image compression unit 38 converts the R signal, the G signal, and the B signal of the RGB color system into the Y signal, the Cb signal, and the Cr signal of the YCbCr color system for each pixel (step S11).

Image compression unit 38 repeatedly executes the processing from step S12 to step S16 described below for each block 60 included in input image 50 (loop A).

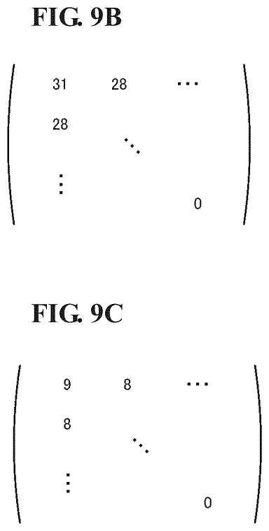

That is, image compression unit 38 performs a discrete cosine transform on block 60 to be processed (step S12). FIG. 9A is an example of a matrix of DCT coefficients resulting from the discrete cosine transform. The matrix has DCT coefficients of 8 rows×8 columns as elements, and the DCT coefficients indicate frequency components in block 60. The upper left side of the matrix indicates a low frequency component, and the lower right side indicates a high frequency component.

Image compression unit 38 determines whether block 60 to be processed is a target region or a non-target region on the basis of the information acquired from target region extraction unit 37 (step S13).

If block 60 to be processed is the target region (YES in step S13), image compression unit 38 quantizes the DCT coefficients using the first quantization table (step S14). On the other hand, if block 60 to be processed is a non-target region (NO in step S13), image compression unit 38 quantizes the DCT coefficients using the second quantization table (step S15). That is, image compression unit 38 performs quantization by dividing each DCT coefficient shown in FIG. 9A by the quantization coefficient at the corresponding position in the quantization table of 8 rows×8 columns.

Here, it is assumed that the first quantization table and the second quantization table are determined such that the number of levels after quantization using the first quantization table is larger than the number of levels after quantization using the second quantization table. That is, when the first quantization table and the second quantization table at the same matrix position are compared, the quantization coefficient of the first quantization table is smaller than the quantization coefficient of the second quantization table.

FIG. 9B is a diagram illustrating an example of DCT coefficients after quantizing the DCT coefficients shown in FIG. 9A using the first quantization table. FIG. 9C is a diagram illustrating an example of DCT coefficients after quantizing the DCT coefficients shown in FIG. 9A using the second quantization table.

For example, the DCT coefficients after quantization using the first quantization table shown in FIG. 9B have 32 levels from 0 to 31, and the DCT coefficients after quantization using the second quantization table shown in FIG. 9C have 10 levels from 0 to 9.

Referring again to FIG. 8, image compression unit 38 compresses the quantized DCT coefficients with run-length compression and performs Huffman encoding on the run-length (step S16).

Referring again to FIG. 7, image compression unit 38 adds the information of the target region and object type extracted by target region extraction unit 37 to compressed input image 50 (step S4).

Image compression unit 38 transmits compressed input image 50 to which the target region information and the object type information are added in step S4 to server 4 via communication unit 32 (step S5).

[Configuration of Server 4]

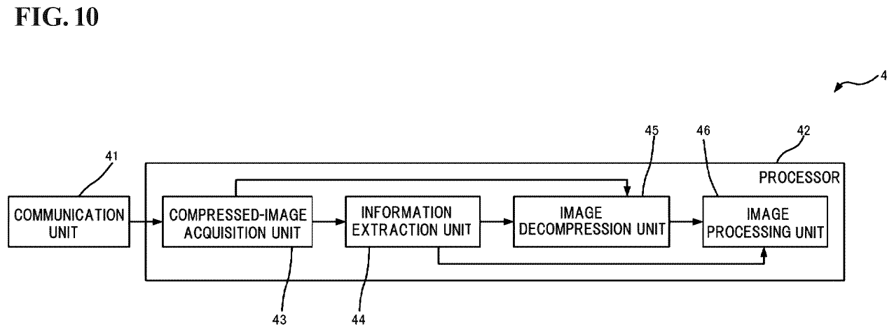

FIG. 10 is a block diagram illustrating an example of a configuration of server 4 according to the first embodiment of the present disclosure.

Referring to FIG. 10, server 4 includes a communication unit 41 and a processor 42. Server 4 is a commonly-used computer provided with a CPU, a ROM, a RAM and the like, and FIG. 10 shows a part of them.

Communication unit 41 is a communication module that connects server 4 to network 5. Communication unit 41 receives the compressed image from vehicle 2 via server 4.

Processor 42 is configured by a CPU or the like, and includes a compressed-image acquisition unit 43, an information extraction unit 44, an image decompression unit 45, and an image processing unit 46 as functional processing units realized by executing a computer program stored in a memory such as a ROM or a RAM.

Compressed-image acquisition unit 43 acquires an image that has been compressed from vehicle 2 via communication unit 41. Compressed-image acquisition unit 43 outputs the acquired compressed image to information extraction unit 44 and image decompression unit 45.

Information extraction unit 44 acquires the compressed image from compressed-image acquisition unit 43. Information extraction unit 44 extracts the target region information and the object type information added to the compressed image from the compressed image. Information extraction unit 44 outputs the extracted information to image decompression unit 45 and image processing unit 46.

Image decompression unit 45 acquires the compressed image from compressed-image acquisition unit 43 and acquires the target region information from information extraction unit 44. Image decompression unit 45 decompresses the compressed image based on the target region information. That is, image decompression unit 45 decompresses the target region by a decompression method corresponding to the compression method of the target region, and decompresses the non-target region by a decompression method corresponding to the compression method of the non-target region. A method of decompressing the compressed image by image decompression unit 45 will be described later. Image decompression unit 45 outputs the decompressed image to image processing unit 46.

Image processing unit 46 acquires the target region information and the object type information from information extraction unit 44, and acquires the decompressed image from image decompression unit 45.

Image processing unit 46 performs predetermined image processing on the decompressed image on the basis of the target region information and the object type information. As an example, image processing unit 46 performs the recognition processing on the target region using the object type as a clue. For example, when the object type is road sign, the recognition of road sign is performed by performing pattern matching processing using pattern images of various road signs. Thus, the recognition processing can be performed efficiently and accurately.

Image processing unit 46 may create a dynamic map in which the recognition result is reflected on the map data and transmit the dynamic map to each vehicle 2 via communication unit 41.

[Flow of Processing of Server 4]

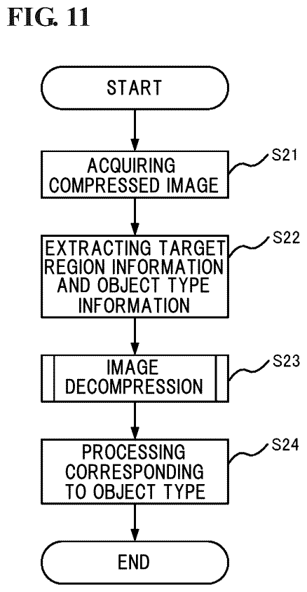

FIG. 11 is a flowchart illustrating a processing procedure of server 4 according to the first embodiment of the present disclosure.

Compressed-image acquisition unit 43 acquires a compressed image from vehicle 2 via communication unit 41 (step S21).

Information extraction unit 44 extracts the added target region information and object type information from the compressed image (step S22).

Image decompression unit 45 decompresses the compressed image based on the target region information (step S23).

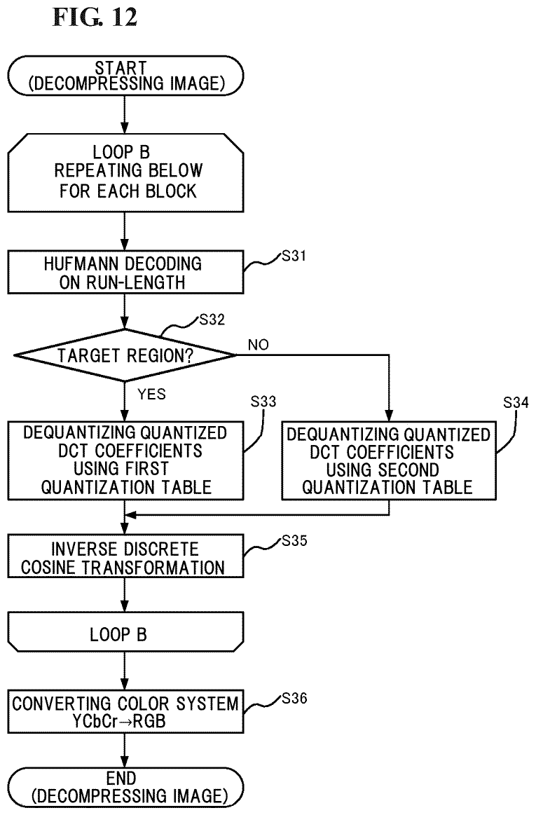

FIG. 12 is a flowchart illustrating the details of the image decompression processing (step S23 of FIG. 11). The image decompression processing shown in FIG. 12 is an application of JPEG decompression.

Referring to FIG. 12, image decompression unit 45 repeatedly executes the processing of steps S31 to S35 described below for each block 60 included in the compressed image (loop B). Block 60 included in the compressed image is the same as block 60 included in input image 50.

Image decompression unit 45 calculates a run-length by performing Huffman decoding on data corresponding to block 60 to be processed. Image decompression unit 45 also calculates quantized DCT coefficients by decompressing the calculated run-length (step S31).

Image decompression unit 45 determines whether or not block 60 to be processed is a target region based on the target region information acquired from information extraction unit 44 (step S32).

If block 60 to be processed is the target region (YES in step S32), image decompression unit 45 calculates DCT coefficients by dequantizing the quantized DCT coefficients using the first quantization table (step S33). On the other hand, if block 60 to be processed is a non-target region (NO in step S32), image decompression unit 45 calculates DCT coefficients by dequantizing the quantized DCT coefficients using the second quantization table (step S34). Here, the first quantization table and the second quantization table are respectively the same as the first quantization table and the second quantization table used by image compression unit 38 of the vehicle-mounted system 3 to quantize the DCT coefficients.

For example, image decompression unit 45 dequantizes each compressed DCT coefficient shown in FIG. 9B by multiplying it by the quantization coefficient at the corresponding location in the first quantization table having 8 rows×8 columns. Similarly, image decompression unit 45 dequantizes each compressed DCT coefficient shown in FIG. 9C by multiplying it by the quantization coefficient at the corresponding location in the second quantization table having 8 rows×8 columns.

Image decompression unit 45 calculates a Y signal, a Cb signal and a Cr signal of each pixel by performing a discrete cosine transform on the dequantized DCT coefficients of 8 rows×8 columns (S35).

After the processing from step S31 to step S35 is completed for all blocks 60 in the compressed image (loop B), image decompression unit 45 converts the color system in the image (step S36). That is, each pixel in the image includes a Y signal, a Cb signal, and a Cr signal of the YCbCr color system. Image decompression unit 45 converts the Y signal, the Cb signal, and the Cr signal of the YCbCr color system into the R signal, the G signal, and the B signal of the RGB color system for each pixel (step S36).

Referring to FIG. 11 again, image decompression unit 45 outputs the decompressed image to image processing unit 46. Image processing unit 46 performs predetermined image processing on the decompressed image on the basis of the information acquired from information extraction unit 44 (step S24). For example, image processing unit 46 executes recognition processing for recognizing vehicle 2, the person, the traffic light, and the road sign from the image, and creates a dynamic map in which the recognition result is reflected on the map data.

[Comparison Result]

Hereinafter, a comparison result between the object detection method according to the first embodiment and the object detection method using the conventional technique will be described.

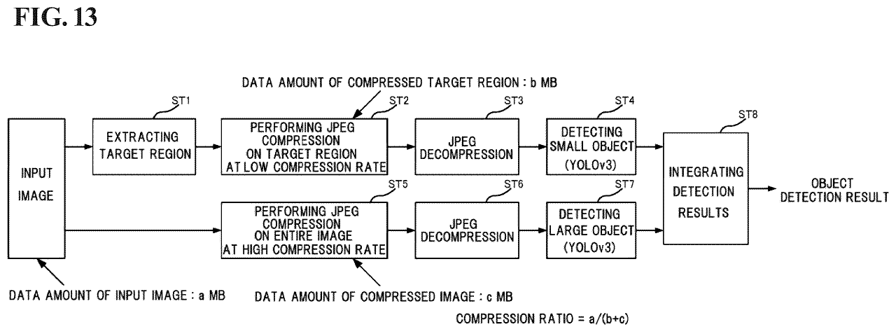

FIG. 13 is a diagram for explaining an object detection method according to the first embodiment. That is, target region extraction unit 37 extracts a target region from an input image of a MB (Mega Byte) (step ST1). Image compression unit 38 performs JPEG compression at a low compression ratio on the target region (step ST2). The compression method is the same as that described above. The data amount of the target region after the JPEG compression at the low compression ratio is b MB.

Image decompression unit 45 performs JPEG decompression on the data of the target region compressed in step ST2 (step ST3). This decompression method is the same as that described above.

Image processing unit 46 detects a small object (i.e., an object having the size shown in Equation 1) from the target region after the JPEG expansion in step ST3 (step ST4). The machine learning model of YOLOv3 (You Only Look Once v3) is used for object detection.

On the other hand, target region extraction unit 37 performs JPEG compression on the entire input image at a higher compression ratio than the JPEG compression of the target region (step ST5). This compression method is the same as the above-described compression method for the non-target region. The data amount of the image after JPEG compression at a high compression ratio is represented by c MB.

Image decompression unit 45 performs JPEG decompression on the image compressed in step ST5 (step ST6). This decompression method is the same as the decompression method for the non-target region described above.

Image processing unit 46 detects a large object (i.e., an object larger than the size shown in Equation 1) from the image after JPEG expansion in step ST6 (step ST7). The YOLOv3 of the machine learning model is used for object detection.

Image processing unit 46 integrates the object detection result in step ST4 and the object detection result in step ST7. That is, when an object is detected at the same position in both steps ST4 and ST7, image processing unit 46 selects the object having a higher certainty factor of object detection output from the YOLOv3 as a detection result.

It is assumed that the compression ratio of the input image obtained by performing compression in steps ST2 and ST5 is calculated by the following Equation 2.

Compression ratio=a/(b+c) (Equation 2)

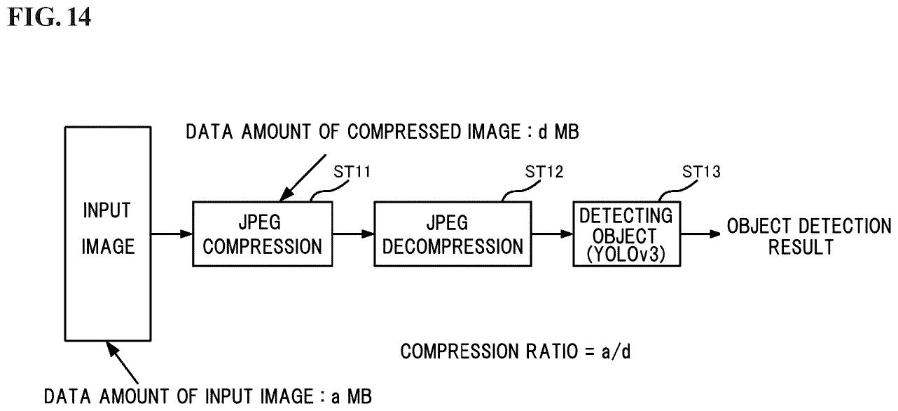

FIG. 14 is a diagram for explaining an object detection method using a conventional technique. That is, image compression unit 38 performs normal JPEG compression on the entire input image (step ST11). The data amount of the image after the JPEG compression is d MB.

Image decompression unit 45 performs JPEG decompression on the image compressed in step ST11 (step ST12).

Image processing unit 46 detects an object from the image after the JPEG decompression in step ST12 (ST13). The object to be detected includes both the small object and the large object described above. The YOLOv3 of the machine learning model is used for object detection.

It is assumed that the compression ratio of the input image obtained by performing compression in step ST11 is calculated by the following Equation 3.

Compression ratio=a/d (Equation 3)

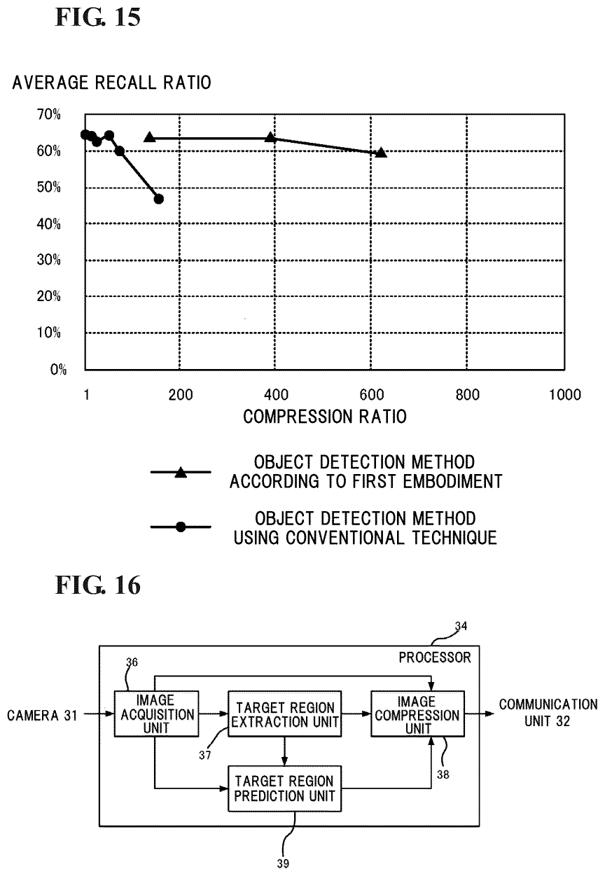

FIG. 15 is a diagram illustrating experimental results of the object detection method according to the first embodiment and the object detection method using the conventional technique. The horizontal axis of the graph shown in FIG. 15 represents the compression ratio, and the vertical axis represents an average recall ratio. The compression ratio is a value calculated by Equation 2 or Equation 3. The recall ratio indicates a ratio (percentage) between the number of objects that can be accurately detected from one image and the number of actual objects included in the image. The average recall ratio indicates an average value of recall ratios of a plurality of images.

As can be seen from the graph shown in FIG. 15, in the object detection method using the conventional technique, the average recall ratio rapidly decreases as the compression ratio increases. On the other hand, in the object detection method according to the first embodiment, even if the compression ratio is increased, the average recall ratio decreases only moderately. In addition, it can be seen that the average recall ratio is higher in the object detection method according to the first embodiment than in the object detection method using the conventional technique at almost the same compression ratio (compression ratio of about 150).

### Effects of First Embodiment

As described above, vehicle-mounted system 3 includes target region extraction unit 37 that extracts a target region, which is a region including an object having a predetermined size, from the image captured by camera 31, and image compression unit 38 that compresses the image based on the extraction result of the target region. Thus, by setting the compression ratio of the target region to such an extent that the object having the predetermined size included in the target region can be accurately recognized when the compressed image is decompressed and object recognition is performed, image compression at a high compression ratio and accurate object recognition from the decompressed image can be realized.

Image compression unit 38 compresses the image so that the compression ratio in the target region in the image is lower than the compression ratio in the non-target region. Therefore, the target region can be compressed at a compression ratio lower than that of the non-target region. For example, by setting the predetermined size to a size including a small object, image compression at a high compression ratio and accurate object recognition from an image after decompression can be realized.

Also, target region extraction unit 37 further extracts the type of the object included in the target region, and image compression unit 38 further adds information about the type of the object to the compressed image. Therefore, when object recognition is performed by expanding the compressed image, processing according to the type of the object can be performed.

Further, target region extraction unit 37 extracts the target region which is a region including an object of a type corresponding to the use of the compressed image and an object having the predetermined size. Therefore, the type of the object to be processed can be changed for each use of the compressed image. Thus, it is possible to realize object recognition according to use.

Camera 31 is mounted on vehicle 2. Therefore, the compressed image can be utilized for safe driving assistance of vehicle 2.

### Second Embodiment

In the first embodiment, target region extraction unit 37 of vehicle-mounted system 3 extracts the target region from each of the time-series images acquired from camera 31. The second embodiment is different from the first embodiment in that a target region is extracted from a part of time-series images and a target region is predicted for the other images.

The configuration of driving assistance system 1 according to the second embodiment is similar to that of the first embodiment. However, the configuration of vehicle-mounted system 3 is partially different from that of the first embodiment.

FIG. 16 is a block diagram illustrating a functional configuration of processor 34 included in vehicle-mounted system 3 according to the second embodiment of the present disclosure.

Referring to FIG. 16, processor 34 includes image acquisition unit 36, target region extraction unit 37, image compression unit 38, and a target region prediction unit 39 as functional processing units realized by executing a computer program stored in memory 35.

The configuration of image acquisition unit 36 is similar to that of the first embodiment. However, image acquisition unit 36 further outputs the input image to target region prediction unit 39.

The configuration of target region extraction unit 37 is similar to that of the first embodiment. However, target region extraction unit 37 extracts a target region from an extraction target frame among the time-series input images (frames), and does not extract a target region from the other frames. It is assumed that the extraction target frame is determined in advance. For example, odd-numbered frames among the time-series frames are set as the extraction target frames, and even-numbered frames are not set as the extraction target frames. Note that the method of determining the extraction target frame is not limited to this. For example, the extraction target frame may be selected every three frames. Target region extraction unit 37 outputs the target region information to target region prediction unit 39.

Target region prediction unit 39 acquires a frame (hereinafter referred to as “prediction target frame”) other than the extraction target frames from image acquisition unit 36. In addition, target region prediction unit 39 acquires the target region information from target region extraction unit 37.

Target region prediction unit 39 predicts, on the basis of the target region extracted from the first image captured by camera 31 at the first time and the second image captured by camera 31 at the second time different from the first time, the target region in the second image. For example, the first time is a photographing time of an odd-numbered frame, and the second time is a photographing time of an even-numbered frame. That is, target region prediction unit 39 predicts the target region in the prediction target frame based on the prediction target frame and the target region extracted from the extraction target frame.

Specifically, target region prediction unit 39 predicts a movement of the target region on the basis of the prediction target frame and the target region extracted from the extraction target frame.

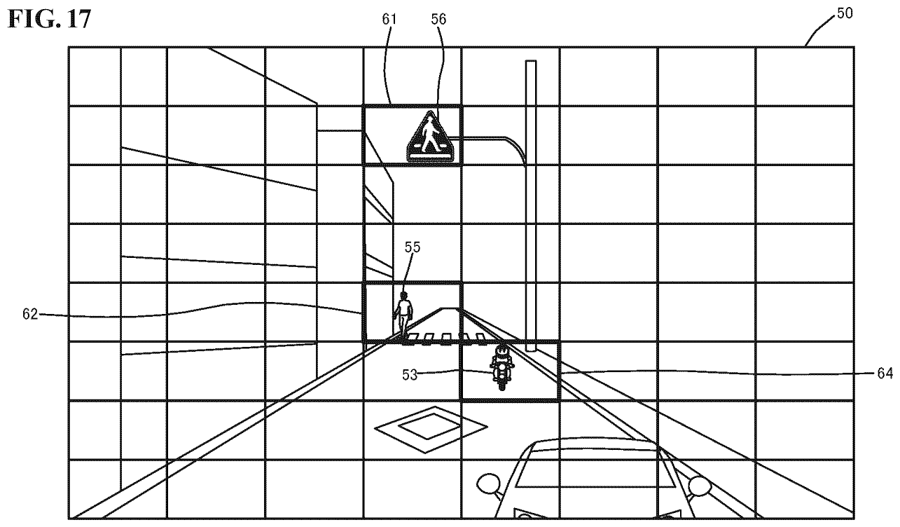

For example, when input image 50 shown in FIG. 6 is the extraction target frame, target region extraction unit 37 extracts target region 61, target region 62, and target region 63. FIG. 17 is a diagram illustrating an example of a prediction target frame. Input image 50 shown in FIG. 17 is an example of the prediction target frame, and is assumed to be a frame captured at a later time (for example, one frame later) than the extraction target frame shown in FIG. 6. Person 55 shown in FIG. 6 has moved to the left in input image 50, and motorcycle 53 and target region 63 have moved to the lower right in input image 50. Road sign 56 is not moving. It is assumed that camera 31 is stopped. However, camera 31 may be moving.

Target region prediction unit 39 calculates movement vectors of target region 61, target region 62, and target region 63 by performing pattern matching processing on input image 50 shown in FIG. 17 using each of target region 61, target region 62, and target region 63 shown in FIG. 6 as a template image. For example, when the centers of target region 61, target region 62, and target region 63 are set as the start points of the movement vectors, it is assumed that the end points of the movement vectors of target region 61 and target region 62 are within target region 61 and target region 62, respectively. On the other hand, it is assumed that the end point of the movement vector of target region 63 is located in the next lower block.

Target region prediction unit 39 predicts the target region in the prediction target frame on the basis of the target region and the calculated movement vector of the target region. For example, target region prediction unit 39 predicts target region 61 and target region 62 as the target regions because the end points of the movement vectors are in target region 61 and target region 62, respectively. On the other hand, with respect to target region 63, since the end point of the movement vector is located in the next lower block, target region prediction unit 39 predicts target region 64 obtained by moving target region 63 to the next lower block as the target region.

Although target region prediction unit 39 performs pattern matching in units of target regions, the present invention is not limited to this. For example, target region prediction unit 39 may extract an object such as motorcycle 53, person 55, or road sign 56 from the target region and calculate movement vectors by performing pattern matching processing using the images of the objects as template images. In addition, target region prediction unit 39 may determine the block to which the end point of the movement vector belongs as the target region. Target region prediction unit 39 outputs information on the predicted target region to image compression unit 38.

Image compression unit 38 acquires target region information about the extraction target frame from target region extraction unit 37, and acquires target region information about the prediction target frame from target region prediction unit 39.

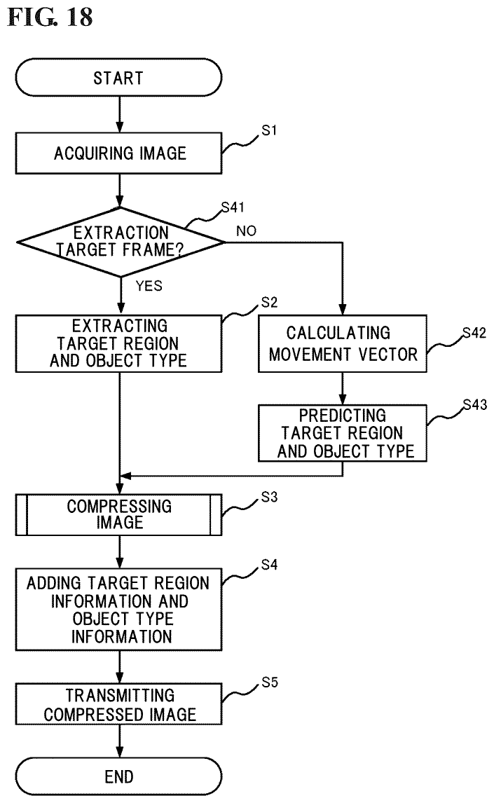

FIG. 18 is a flowchart illustrating a processing procedure of vehicle-mounted system 3 according to the second embodiment of the present disclosure.

Image acquisition unit 36 acquires an image from camera 31 (step S1). Image acquisition unit 36 determines whether or not the acquired image is an extraction target frame (step S41).

If the acquired image is the extraction target frame (YES in step S41), image acquisition unit 36 outputs the extraction target frame to target region extraction unit 37, and target region extraction unit 37 extracts the target region and the object type from the extraction target frame (step S2).

If the acquired image is the prediction target frame (NO in step S41), image acquisition unit 36 outputs the prediction target frame to target region prediction unit 39, and target region prediction unit 39 calculates the movement vector from the prediction target frame and the target region extracted by target region extraction unit 37 (step S42).

Target region prediction unit 39 predicts the target region in the prediction target frame on the basis of the target region of the extraction target frame extracted by target region extraction unit 37 and the calculated movement vector. Target region prediction unit 39 predicts the type of the object corresponding to the target region of the extraction target frame used for the prediction as the type of the object included in the predicted target region (step S43).

Image compression unit 38 compresses the extraction target frame based on the target region and the object type extracted by target region extraction unit 37, and compresses the prediction target frame based on the target region and the object type predicted by target region prediction unit 39 (step S3). Details of the image compression method are similar to those in the first embodiment.

Image compression unit 38 adds the information of the target region and the object type extracted by target region extraction unit 37 to the compressed extraction target frame, and adds the information of the target region and the object type predicted by target region prediction unit 39 to the compressed prediction target frame (step S4).

Image compression unit 38 transmits compressed input image 50 to which the target region information and the object type information are added in step S4 to server 4 via communication unit 32 (step S5).

As described above, vehicle-mounted system 3 further includes target region prediction unit 39 that predicts the target region in the prediction target frame on the basis of the target region extracted from the first image (extraction target frame) captured at the first time and of the second image (prediction target frame) captured at the second time different from the first time. Further, image compression unit 38 compresses the prediction target frame based on the prediction result by target region prediction unit 39. Therefore, the process of extracting the target region from the prediction target frame can be omitted. Thus, the image compression processing can be performed at high speed.

Specifically, target region prediction unit 39 predicts movement of the target region based on the target region extracted from the extraction target frame and on the prediction target frame, and predicts the target region in the prediction target frame based on the predicted movement and on the target region extracted from the extraction target frame. In this way, the target region in the prediction target frame can be predicted from the movement of the target region. This makes it possible to accurately predict the target region in the prediction target frame.

### First Variation

In the first and second embodiments, a block including an object having a predetermined size is extracted as a target region. However, the method of extracting the target region is not limited to this.

For example, target region extraction unit 37 may determine whether or not an object having a predetermined size is included in input image 50 by directly inputting input image 50 to the learning model. Here, the object of the predetermined size is, for example, an object satisfying Equation 1.

The learning model is, for example, CNN, RNN, AutoEncoder, or the like. It is assumed that each parameter of the learning model is determined by a machine learning method such as deep learning using images including objects satisfying Equation 1 and object types as teacher data.

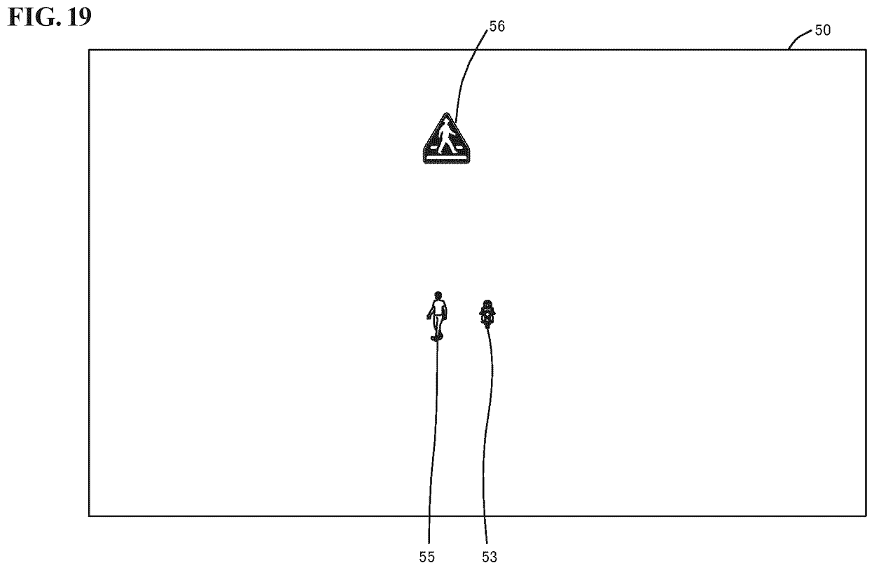

FIG. 19 is a diagram illustrating an example of an object extracted from an input image. For example, target region extraction unit 37 inputs input image 50 shown in FIG. 4 to the learning model. Referring to FIG. 19, the learning model extracts motorcycle 53, person 55, and road sign 56 as objects included in input image 50 and satisfying Equation 1. In addition, target region extraction unit 37 acquires vehicle, person, and road sign, which are the object types of motorcycle 53, person 55, and road sign 56, respectively, from the learning model.

Image compression unit 38 sets a region including the object extracted by target region extraction unit 37 (for example, a circumscribed rectangular region of the object or a block including the object) as a target region, and sets other regions as non-target regions, and performs compression processing in the same manner as in the first embodiment.

### Second Variation

In the first and second embodiments, although the predetermined size indicated in Equation 1 is the same even if the object type is different, the predetermined size may be different for each object type. For example, person and road sign are smaller than vehicle. Therefore, the predetermined size for person or road sign is set to be smaller than the predetermined size for vehicle.

Thus, it is possible to extract a target region having an appropriate size according to the type of the object. For example, by setting the size of the car to be larger than that of the person, it is possible to appropriately extract target regions each including the car and the person.

### Third Variation

In the first and second embodiments, the target region is compressed at the same compression ratio even if the object type is different. However, the compression ratio may be changed for each object type. As a result, for example, by compressing the image including an object of the object type in which recognition accuracy is more important at a lower compression ratio, it is possible to accurately recognize the object of the important type from the decompressed image.

[Supplementary Notes]

The image compression method described above is not limited to JPEG compression, and a compression method capable of changing the compression ratio or two or more compression methods having different compression ratios may be used. For example, for the target region, block data may be irreversibly compressed using an algorithm called Visually Lossless Compression or Visually Reversible Compression with a low compression ratio. For the non-target region, the block may be compressed according to a compression method called JPEG2000 having a high compression ratio.

In addition, for the non-target region, downscaling processing for reducing the non-target region may be performed, or the number of bits indicating the luminance value of each pixel in the non-target region may be reduced to reduce the gradation (color depth). In addition, a temporal thinning process of the non-target region (for example, a processing of deleting non-target regions obtained from even-numbered frames among the time-series images) may be performed.

Some or all of the components constituting each of the above-described devices may be constituted by one or more semiconductor devices such as system LSIs.

The computer program may be recorded on a computer-readable non-transitory recording medium such as an HDD, a CD-ROM, or a semiconductor memory and distributed. Further, the computer program may be transmitted and distributed via an electric communication line, a wireless or wired communication line, a network represented by the Internet, data broadcasting, or the like. In addition, each of the above-described devices may be realized by a plurality of computers or a plurality of processors.

Further, some or all of the functions of the above-described devices may be provided by cloud computing. In other words, some or all of the functions of each device may be implemented by the cloud server. Further, image compression unit 38 may apply the present disclosure to an image in a partial range of the image captured by camera 31. Furthermore, at least some of the above embodiments and modifications may be arbitrarily combined.

The embodiments disclosed herein are to be considered in all respects as illustrative and not restrictive. The scope of the present disclosure is defined not by the above meaning but by the claims, and is intended to include all modifications within the meaning and scope equivalent to the claims.

### REFERENCE SIGNS LIST

1 driving assistance system (image processing system)
2 vehicle
3 vehicle-mounted system (image compression system)
4 server
5 network
6 base station
31 camera
32 communication unit
33 control unit (ECU)
34 processor (image compression apparatus)
35 memory
36 image acquisition unit
37 target region extraction unit
38 image compression unit
39 target region prediction unit
41 communication unit
42 processor
43 compressed-image acquisition unit
44 information extraction unit
45 image decompression unit
46 image processing unit
50 input image
51 road
52 car
53 motorcycle
54 crosswalk
55 person
56 road sign
60 block
61 target region
62 target region
63 target region
64 target region
65 non-target region

1.-13. (canceled)

14. An image compression apparatus comprising:
a target region extraction circuit configured to divide an image into block images, determine whether an object having a predetermined size within a predetermined range is included in each of the block images, extract a block image including the object having the predetermined size as a target region; and
an image compression circuit configured to compress the image after determining a compression ratio for each of block images based on an extraction result of the target region.

15. The image compression apparatus according to claim 14, wherein the image compression circuit is configured to compress the image such that a compression ratio in the target region in the image is lower than a compression ratio in a region, in the image, other than the target region.

16. The image compression apparatus according to claim 14, wherein
the target region extraction circuit is configured to further extract a type of the object included in the target region, and
the image compression circuit is configured to further add information about the type of the object to the image that has been compressed.

17. The image compression apparatus according to claim 14, wherein the target region extraction circuit is configured to extract the target region that is a region including an object that has the predetermined size and that is of a type corresponding to a use of the image that has been compressed.

18. The image compression apparatus according to claim 14, wherein the predetermined size differs depending on a type of the object.

19. The image compression apparatus according to claim 14, wherein the image compression circuit is configured to compress the image at a compression ratio corresponding to a type of the object included in the target region.

20. The image compression apparatus according to claim 14, further comprising:
a target region prediction circuit configured to predict, on the basis of the target region extracted from a first image captured at a first time and on the basis of a second image captured at a second time different from the first time, the target region in the second image, wherein
the image compression circuit is configured to compress the second image on the basis of a result of prediction by the target region prediction circuit.

21. The image compression apparatus according to claim 20, wherein the target region prediction circuit is configured to predict a movement of the target region on the basis of the target region extracted from the first image and on the basis of the second image and predict the target region in the second image on the basis of the predicted movement and the target region extracted from the first image.

22. The image compression apparatus according to claim 14, wherein the image is captured by a camera mounted in a moving body.

23. An image compression method comprising:
dividing an image into block images, determine whether an object having a predetermined size within a predetermined range is included in each of the block images, extract a block image including the object having the predetermined size as a target region; and
compressing the image after determining a compression ratio for each of block images based on an extraction result of the target region.

24. A non-transitory computer-readable storage medium storing a computer program for causing a computer to function as:
a target region extraction circuit configured to divide an image into block images, determine whether an object having a predetermined size within a predetermined range is included in each of the block images, extract a block image including the object having the predetermined size as a target region; and
an image compression circuit configured to compress the image after determining a compression ratio for each of block images based on an extraction result of the target region.

25. An image compression system comprising:
a camera mounted in a moving body; and
the image compression apparatus according to claim 14, the image compression apparatus being configured to compress an image captured by the camera.

26. An image processing system comprising:
the image compression apparatus according to claim 14; and
an image decompression apparatus configured to acquire from the image compression apparatus, an image that has been compressed and decompress the acquired image that has been compressed.

27. The image compression apparatus according to claim 15, wherein
the target region extraction circuit is configured to further extract a type of the object included in the target region, and
the image compression circuit is configured to further add information about the type of the object to the image that has been compressed.

28. The image compression apparatus according to claim 15, wherein the target region extraction circuit is configured to extract the target region that is a region including an object that has the predetermined size and that is of a type corresponding to a use of the image that has been compressed.

29. The image compression apparatus according to claim 16, wherein the target region extraction circuit is configured to extract the target region that is a region including an object that has the predetermined size and that is of a type corresponding to a use of the image that has been compressed.

30. The image compression apparatus according to claim 15, wherein the predetermined size differs depending on a type of the object.

31. The image compression apparatus according to claim 16, wherein the predetermined size differs depending on a type of the object.

32. The image compression apparatus according to claim 17, wherein the predetermined size differs depending on a type of the object.

33. The image compression apparatus according to claim 15, wherein the image compression circuit is configured to compress the image at a compression ratio corresponding to a type of the object included in the target region.
